(19) United States
(12) Patent Application Publication
(10) Pub. No.: US 2012/0156980 A1
(43) Pub. Date: Jun. 21, 2012

(54) ATMOSPHERE FLAVORING SYSTEM AND AN ELECTRONIC DEVICE

(76) Inventor: Marcelo Lazaro Zelicovich, Aventura, FL (US)

(21) Appl. No.: 13/325,892

(22) Filed: Dec. 14, 2011

(30) Foreign Application Priority Data
Dec. 17, 2010 (AR) 2010 0104736

(51) Int. Cl. B60H 3/02

(52) U.S. Cl. 454/157

(57) ABSTRACT

This is a new system to aromatize spacious rooms, such as apartments, offices, factories, among other possible premises, such as shops, hotels or even large means of transport such as ships or ocean liners, all of which in many cases are likely to have central ventilation facilities.

This new room aromatization concept results from the implementation of a scent dispensing device or apparatus comprising an electromechanical device or mechanism, that is automatic and programmable, and an aerosol container containing liquid that is either an aromatization product, sanitizer or the like, which is then sprayed onto the area where the device is located, as a result of the programmed automatic action of the device.

This device, installed close to the location of the air filters that are placed in the outlets of the ducts of a forced ventilation system of a central air conditioning equipment, makes multiple continued shots according to the timing frequency programmed by the user, spraying the contents of the product as a fragrance cloud, which while being carried by the airflow in that area, will impact directly against the air filters of the ventilation system, and they will be impregnated with thousands of micro particles of the product that were sprayed by the electronic device.

These micro particles, due to the high degree of concentration, are able to remain active in the air filter for a long time, and they are mixed with the air stream of the room, transforming the air stream into a scented stream that will be directed toward the different rooms, where it will be spread evenly.

The electronic device, if properly programmed with a certain frequency determined by the user, will expel the contents of the aromatization product in a controlled and constant manner, enhancing the product performance and the aromatic effect in the rooms for long periods of time and improving the devices already known to aromatize environments.

### FIELD OF INVENTION

The present invention relates to a room aromatization system and an electronic automatic device which can be programmed for the controlled release of liquid products by atomization, vaporization, spraying; linked to a forced ventilation duct or the like; particularly, a system in which a dispenser is applied, which can be programmed at different frequencies to aromatize spacious rooms that have forced ventilation systems or facilities such as central air conditioning, extractors, fans or other mechanisms that facilitate air movement within a closed environment.

The object of this invention essentially stands out for providing a new systematic-operative option, since it turns central air conditioning devices into large scented air dispensers.

This functioning principle of controlled release of aromatization products will be used to aromatize spacious rooms for long periods of time, through an externally generated ventilation current, avoiding the current need for multiple aromatization devices, but rather installing a single centralized device.

The dispensing device will be located within a certain radius of influence in a ventilation circuit, close to the location of the air filters and wherein the air flow is generated.

This dispensing device will be programmed to spray automatically and on a controlled manner, a fragrant cloud which, when absorbed by the air flow and upon impacting on the air conditioning unit, will cause them to be impregnated with the fragrance, therefore making it possible for the air that goes through the filter to be mixed with the fragrance micro particles, turning into a scented air current that will be spread on the room or rooms wherein the equipment is applied.

This invention can be considered as the combination of two elements. On the one hand, a perfume dispensing apparatus having an electronic, automatic and programmable device, using an aerosol container of certain characteristics, which contains liquid with high concentration of different aromatic fragrances or sanitizing products, bactericides or any other product that may be necessary to perform some treatment in the air. The other part is the central forced ventilation system itself. This aromatization apparatus, its electronic, automatic, programmable device, and the fragrance, applied to a central ventilation flow, due to the high concentration of the aromatization product and its composition, results in a better performance and higher yield as far as room aromatization or air treatment are concerned, compared to the prior art. Also, its structural, functional and disposition conditions entail inventive step.

### PRIOR ART

Concerning the prior art in this field, although many of the current room aromatization systems are also automatic and programmable, they are localized and have a short range of influence, and they generally function in an isolated manner, within a specific room, which logically results in a smaller range of influence of the aromatization liquid. The aromatization devices that function with scented pellets are also known. They entail a minor impact of the aromatization product on the ventilated rooms because the aromatization effect decreases when the pellets start to dry up over time. There are other room aromatization methods, but most of them are manual, and involve air fresheners, incense, essential oils heated by candles, in which the user himself must manually implement these products, in order to obtain the result desired; including gel-type chemical compositions that are applied directly on the air filters and, just as the aromatization pellets, represent not only a lower product yield but also in the latter case, the eventual clogging of the filter pores by the residues of these compositions, thereby obstructing the passage of ventilation in the long term.

All these systems have operational and/or functional limitations and, in some cases, their residues are not recyclable. In this regard, other devices for the controlled release of fragrances or scented spray for spacious rooms, applied and adapted to a central ventilation system that present the innovative features and benefits provided by the present invention are not known.

### ADVANTAGES OF THE INVENTION

As it is understood, the main function of the automatic programmable air freshener device applied within a system of central forced ventilation air stream is to dispense a certain product which is highly concentrated, said product being either aromatic, sanitizing, bactericide or the like. As a result of its automated actuation, it releases micro particles of the product in a controlled manner and when the filters of a central ventilation mechanism are impregnated with them, they remain effective therein for a long time, thus mixing themselves with the incoming air flow that travel through the closed ducts, thereby reaching the targeted room or rooms. In this case, the filter acts as a large flower petal, since when the air goes through at high speed, according to Bernoulli's theorem, the pressure decreases and promotes fragrance evaporation. The air flow in the room then spreads the scent therein.

It is worth noting that present invention was particularly developed for use in centralized air-conditioning equipment, but it may also probably be used with similar efficacy in any place where there is a forced ventilation system. According to the present invention, the system uses a programmable automatic air freshener device, which will be programmed according to the frequency in which it is desired that the product be sprayed, thereby controlling it electronically and automatically, permitting the air freshening effect to last longer. It is precisely the regular repetition of the spraying in our system that makes it far superior to those known in the prior art, since this system makes it possible for the perfume to be dispersed along the rooms in a homogeneous and continuous manner according to the schedule programmed in the equipment.

Therefore, an object of the present invention is to provide an aromatization system that involves an automatic programmable air freshener device for the controlled release of liquid products in rooms by atomization, vaporization, spraying and the like, including aerosol contained in an aluminum container, filled with Dymel 134 A propellant, fragrances made with essential oils and natural aromatic chemicals, or even pure natural essential oils, sanitizing products, bactericides or any other product that may be necessary to perform air treatment.

The electronic device implemented to facilitate this system is programmable and does not require an external electric current, since it is battery-operated, and it therefore does not need any permission in view of the eventual electrical hazard, unlike other inventions of the prior art.

The device is totally silent, safe and the elements forming the air freshener are completely recyclable, thereby reducing any impact on the environment.

In order for the device to act effectively, only 260 grams (+ −250 ml) of the air freshener are necessary. As a result, the amounts dispensed every time the product is sprayed are small and offer high yields.

The impregnation of these micro particles on the filters of the air conditioning system, due to their composition, pose no risk to the system, thus ensuring the preservation and extension of the useful life of the equipment, therefore avoiding any blockage of the filters or any other damage of this kind.

The small size of the device makes its installation in any central air conditioning equipment easier, and its total weight does not exceed 760 grams. This makes it practical and very easy to use for any user, even those who have no previous experience.

### INVENTIVE STEP

None of the systems known in the prior art for aromatizing rooms discloses the structural and functional solution that arises from the explanation contained in the preceding paragraphs. Thus, the invention is not only novel, but it also involves an inventive step.

### BRIEF DESCRIPTION OF THE DRAWINGS

For greater clarity and understanding of the object of the present invention and of its advantages that have been briefly discussed, the invention is illustrated in several drawings that represent the preferred embodiments of the invention, schematically and without a defined scale, in the attached sheets. It is expressly stated that, since these constitute examples, they do not limit the scope of protection of this invention, but they rather merely explain and illustrate the basic concept lying beneath the invention.

FIG. 1 is a front view of the fragrance dispensing apparatus of aromas and its components.

FIG. 2 is an exploded perspective view of the dispensing apparatus.

FIG. 3 is an exploded perspective view of the electromechanical device or mechanism.

FIG. 4 is a descriptive sketch of the operation of the dispensing apparatus.

FIG. 5 is a descriptive sketch of the functioning of the whole aromatization system.

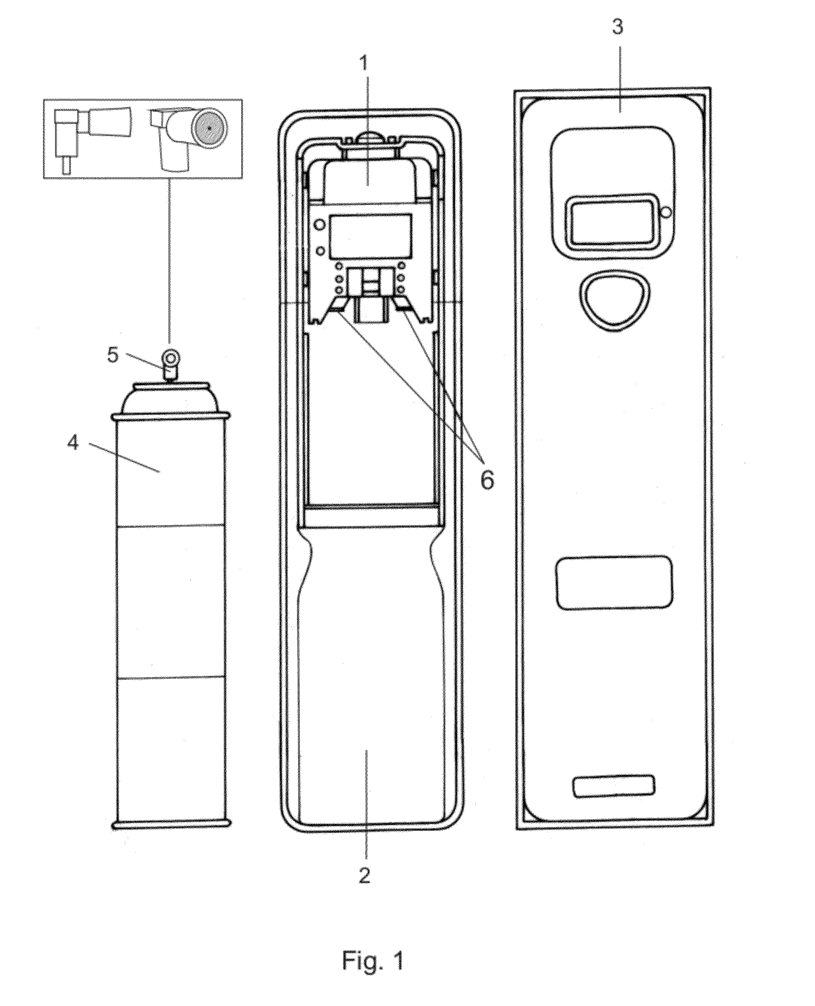

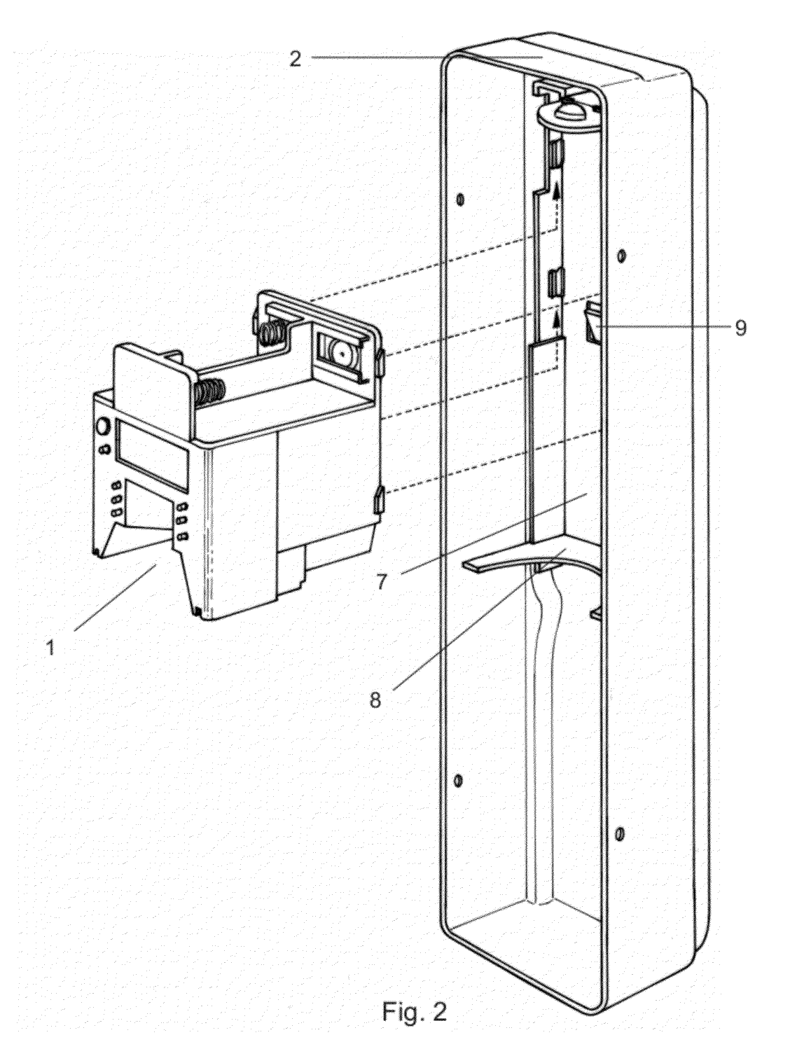

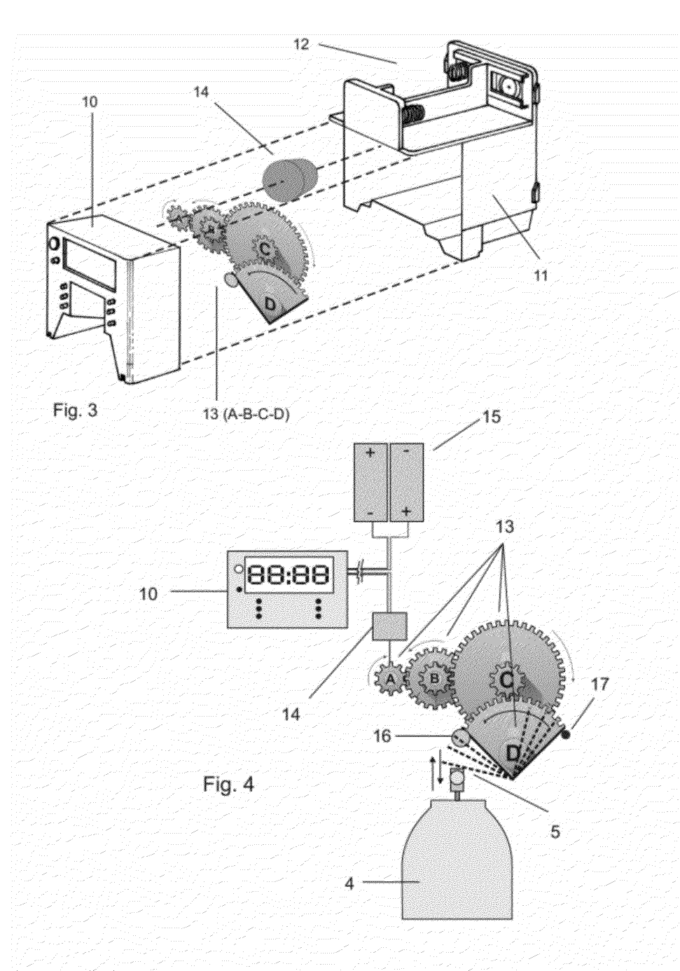

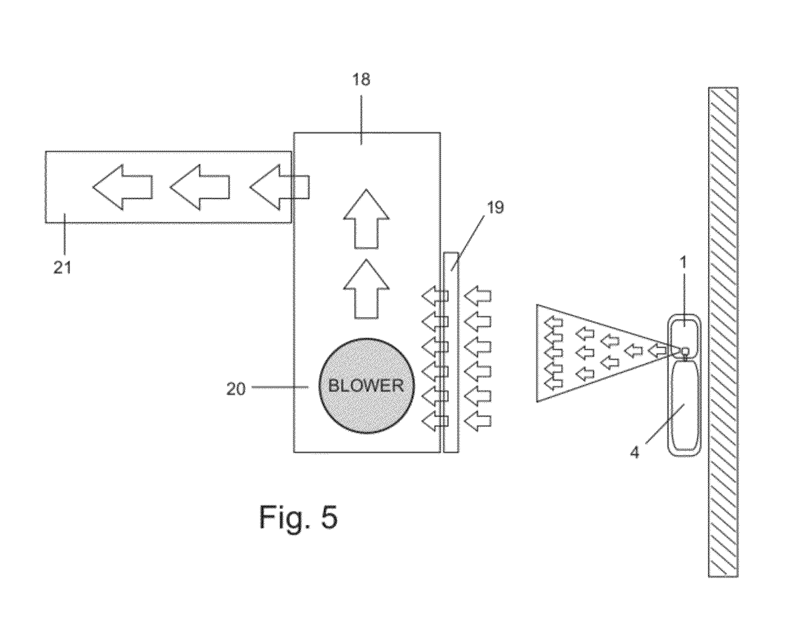

It is clarified that in all the figures, the same reference numbers refer to the same parts or component elements of the set, or to equivalent parts or elements, according to the example chosen to explain the devised system.

### DETAILED DESCRIPTION OF A PREFERRED EXAMPLE

As shown in Figure One, the programmable automatic electronic dispenser for the controlled release of liquid products by atomization, vaporization, spraying or the like used in the present aromatization system is formed in this ideal example by an electromechanical mechanism or device (1), which is located within a rigid polypropylene casing having a back cover (2) and a front cover (3). Also, an aluminum aerosol container (4) filled with Dymel 134 A propellant and fragrances made with essential oils and natural aromatic chemicals will also be placed within said plastic casing. This aerosol container (4) has a nozzle (5) with special characteristics that facilitate the escape of liquid sprayed out of the plastic casing onto its exterior. The aerosol container (4) may be assembled to the electromechanical device (1) by a pair of clamping tabs (6) which will be secured to the container neck. In turn, as shown in Figure Two, a base (7) that is also made of plastic rigid material is attached to the back cover (2), the special end of the base having a U-shape plate (8) that is perpendicular to the base (7), which will also be used to steady the aerosol container (4) and the electromechanical mechanism or device (1).

Said device (1) can be removed from the base (7) through a series of guides and exerting pressure on a tab (9) that is defined in the base (7), to facilitate the placement of the batteries.

The electromechanical device, as shown in Figure Three, is composed by an electronic timer (10), connected by a two-wire cable to a drawer or helmet (11), which has a slot for the batteries (12) which will provide electric supply to operate the device. A mechanical part formed by a series of gears (13A-13B-13C and 13D) and a motor (14) is connected to this circuit. The functioning mechanism is depicted in Figure Four, wherein, as a result of the automatic and programmed actuation of the electronic timer (10) and powered by an electric current supplied by a pair of 1.5 W batteries (15), a small motor (14) is operated, which activates one of the gears clockwise (13A), which in turn activates gear 13B, which activates gear 13C, which finally activates gear 13D, having a special end, consisting of a small partition (16) that acts as a hammer that pounds the nozzle (5), spraying the contents of the container (4) outside the container. Then, the mechanism will take the same steps in reverse order, until gear 13D is back in its initial position, where it will be stopped by a metal piece (17) placed for this purpose.

Also, as the object of the present invention refers to “a room aromatization system and an electronic automatic device which can be programmed for the controlled release of liquid products by atomization, vaporization, spraying; linked to a forced ventilation duct or the like”, it is important to explain how the electronic automatic programmable dispenser is applied and in which context.

Consequently, Figure Five is provided, which is a scheme of the ideal operation of this aromatization system, wherein:

The automatic electronic programmable dispenser is located directly in an area close to a forced ventilation circuit or to a central air conditioning system (18), preferably in an area close to the location of the air filters (19) of the ventilation system.

The dispenser will automatically and due to the scheduled action of the electromechanical mechanism or device (1) spray in a controlled manner a tiny amount of the concentrated product contained in the aerosol container (4) in the form of a fragrant cloud, which will be then dragged by the air flow generated in the room by the absorbing action of the ventilation system itself and of the blower (20) located therein, causing the sprayed product to impact directly on the air filters (19). This aromatization product, due to its composition and its high concentration, will deposit a large amount of micro particles on the filters, which will stay active for a long period of time, thus transforming the common air flow into an aromatized stream that will circulate through the ducts (21) of the ventilation system, to the different rooms where it is applied. This aromatization effect will of course be enhanced by the successive automatic atomizations scheduled in the dispenser.

While certain novel features of the present invention have been shown and described, it will be understood that various omissions, substitutions and changes in the forms and details of the device illustrated and in its operation can be made by those skilled in the art without departing from the spirit of the invention.

I claim:

1. A room aromatization system and an electronic automatic device which can be programmed for the controlled release of liquid products by atomization, vaporization, spraying; linked to a forced ventilation duct or the like; created to scent spacious rooms by transforming a standard forced ventilation system into an efficient fragrance dispenser of the kind that comprises:
an electronic automatic programmable dispensing device; and
an aerosol container filled with highly concentrated liquid to be sprayed within a forced central ventilation system
CHARACTERIZED IN THAT said electronic automatic programmable dispensing device comprises at least one electromechanical mechanism to spray liquid connected to a portable electric power source, where the electronic automatic programmable dispensing device, implemented within a forced air ventilation circuit, is arranged so that upon automatically activating the dispensing device in a programmed manner, the liquid contained in the aerosol container is sprayed as a fragrance cloud, and is then carried by the air flow generated in that area, and absorbed by the ventilation system, impacting directly on its air filters, which will be impregnated with thousands of micro particles of the product sprayed by the electronic dispensing device, transforming a simple airflow into a scented air stream.

2. A room aromatization system and an electronic automatic device which can be programmed for the controlled release of liquid products by atomization, vaporization, spraying; linked to a forced ventilation duct or the like, according to claim 1,
CHARACTERIZED IN THAT said electromechanical spraying device comprises
at least one device programming circuit;
at least one motor; and
at least one gear driven by the motor, which gear controls the release of the liquid products.

3. A room aromatization system and an electronic automatic device which can be programmed for the controlled release of liquid products by atomization, vaporization, spraying; linked to a forced ventilation duct or the like, according to claim 1,
CHARACTERIZED IN THAT, the portable electric power source that supplies the dispensing device uses batteries, and is not required to be connected to an external electric current.

4. A room aromatization system and an electronic automatic device which can be programmed for the controlled release of liquid products by atomization, vaporization, spraying; linked to a forced ventilation duct or the like, according to claim 1,
CHARACTERIZED IN THAT said forced ventilation circuit is a central air conditioning system.

5. A room aromatization system and an electronic automatic device which can be programmed for the controlled release of liquid products by atomization, vaporization, spraying; linked to a forced ventilation duct or the like, according to claim 1,
CHARACTERIZED IN THAT the aerosol container used in the dispensing device comprises at least one container filled with a propellant and a fragrance comprised of at least one of essential oils and natural aromatic chemicals.

6. A room aromatization system and an electronic automatic device which can be programmed for the controlled release of liquid products by atomization, vaporization, spraying; linked to a forced ventilation duct or the like, according to claim 1,
CHARACTERIZED IN THAT said electronic automatic programmable dispensing device and the aerosol container are arranged within a rigid polypropylene casing.

7. A room aromatization system and an electronic automatic device which can be programmed for the controlled release of liquid products by atomization, vaporization, spraying; linked to a forced ventilation duct or the like, according to claim 2,
CHARACTERIZED IN THAT said device programming circuit comprises at least one programmable electronic timer to schedule the operation of the dispensing device.

8. A room aromatization system and an electronic automatic device which can be programmed for the controlled release of liquid products by atomization, vaporization, spraying; linked to a forced ventilation duct or the like, according to claim 2,
CHARACTERIZED IN THAT one of the gears of the mechanism comprises a special coating on one end which defines a small partition that activates the device.

9. A room aromatization system and an electronic automatic device which can be programmed for the controlled release of liquid products by atomization, vaporization, spraying; linked to a forced ventilation duct or the like, according to claim 3,
CHARACTERIZED IN THAT the batteries that supply electric power to operate the dispenser are 1.5 w batteries.

10. A room aromatization system and an electronic automatic device which can be programmed for the controlled release of liquid products by atomization, vaporization, spraying; linked to a forced ventilation duct or the like, according to claim 5,
CHARACTERIZED IN THAT the container filled with propellant gas has a nozzle which has special features to facilitate the exit of the liquid to be sprayed.
